(19) United States
(12) Patent Application Publication
(10) Pub. No.: US 2005/0243755 A1
(43) Pub. Date: Nov. 3, 2005

(54) Method and system for adapting wireless network service level

(76) Inventor: Adrian P. Stephens, Cambridge (GB)

Correspondence Address: INTEL CORPORATION, P.O. BOX 5326, SANTA CLARA, CA, 95056-5326, US

(21) Appl. No.: 10/837,195

(22) Filed: Apr. 30, 2004

(51) Int. Cl. H04Q 7/00

(52) U.S. Cl. 370/328

(57) ABSTRACT

Methods and systems for communicating in a wireless network negotiate a level of service for a data stream between peers of the wireless network. The level of service may be modified based on one or more characteristics of a communication link or the wireless network such as channel load, channel free time, physical (PHY) link rate, data rate and/or overall channel capacity. Various specific embodiments and variations are also disclosed.

### BACKGROUND OF THE INVENTION

Due to the increasing use of wireless networks, such as wireless local area networks (WLANs), for media applications, it is becoming more important to be able to provide various levels of service for information having various degrees of importance. For example, in voice or video applications, a minimum level of service may be needed between a remote device and a network station in order to provide a reasonable quality of voice or video.

However, guaranteed service levels may be difficult to achieve in wireless networks since there may be no guarantee that a channel will be sufficiently idle to provide a desired service level (e.g., the channel could be limited by interference or competing channel access). Moreover, if either peer of the link (or anything in the environment) is moving, the channel properties between peers may change so that the desired data rate cannot be achieved.

Accordingly, it would be desirable for wireless networks to be able to provide service levels with improved performance.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a flow diagram detailing a method for adapting a service level in a wireless network according to various embodiments of the present invention;

FIG. 3 is a flow diagram detailing a process for determining whether a service level should be adapted;

FIG. 4 is a block diagram of an example embodiment for a wireless device adapted to perform one or more of the methods of present invention; and

FIG. 5 is a block diagram of an example embodiment for a network access station adapted to perform one or more of the methods of the present invention.

### DETAILED DESCRIPTION OF THE INVENTION

While the following detailed description may describe example embodiments of the present invention in relation to wireless networks utilizing Orthogonal Frequency Division Multiplexing (OFDM) modulation, the embodiments of present invention are not limited thereto and, for example, can be implemented using or other modulation and/or coding schemes where suitably applicable. Further, while example embodiments are described herein in relation to wireless local area networks (WLANs), the invention is not limited thereto and can be applied to other types of wireless networks where providing levels of service may presents similar challenges. Such networks specifically include, but are not limited to, wireless metropolitan area networks (WMANs), wireless personal area networks (WPANs) and wireless wide area networks (WWANs).

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, mobile stations, base stations, access points (APs), gateways, bridges, hubs and cellular radiotelephones. Further, the radio systems within the scope of the invention may include cellular radiotelephone systems, satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

As used herein, a service level or level of service means a communication link capable of supporting a certain minimum criteria such as a threshold data transfer rate, bit error rate and/or other bandwidth or reliability characteristic. Further, as used herein, a traffic specification (TSPEC) is a collection of parameters defining the characteristics of a traffic stream and/or refers to a traffic stream itself

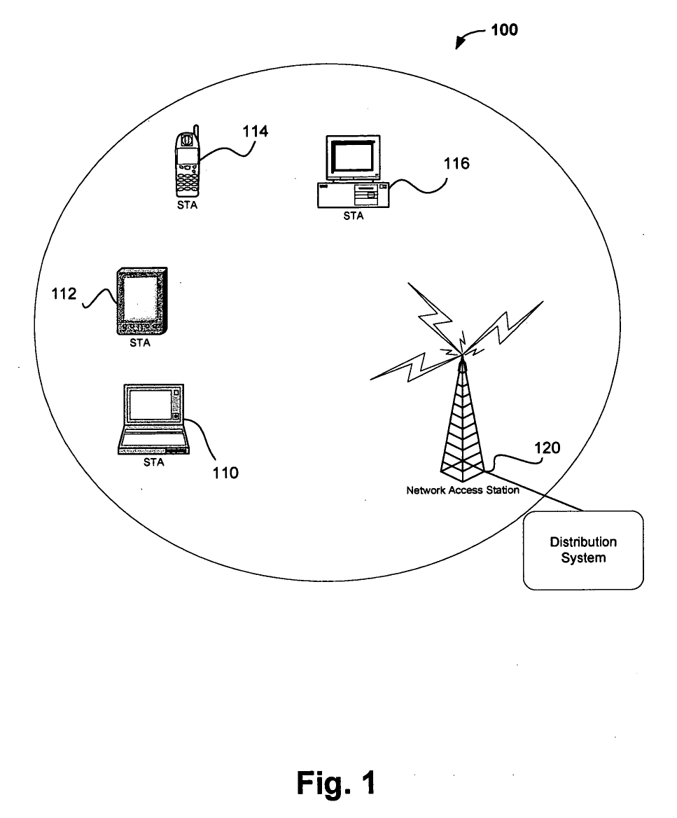

Turning to FIG. 1, a wireless communication system 100 according to one embodiment of the invention may include one or more user stations 110, 112, 114, 116 and one or more network access stations 120. System 100 may be any type of wireless network such as a wireless local area network (WLAN), wireless wide area network (WWAN) or cellular network where user stations 110-116 communicate with network access station 120 via an air interface.

System 100 may further include one or more other wired or wireless network devices as desired. In certain embodiments system 100 may be an adaptive orthogonal frequency division multiplexing (OFDM) wireless local area network (WLAN) although the embodiments of the invention are not limited in this respect. OFDM is the modulation currently used in many wireless applications including the Institute of Electrical and Electronic Engineers (IEEE) 802.11(a) and (g) standards for WLANs.

As previously discussed, peers in a wireless network such as user stations 110, 112, 114 and 116 may need to have certain threshold service levels to support traffic streams for time and/or integrity sensitive applications such as video or voice applications. Negotiation and adaptation of such service levels will now be described in accordance with a specific example implementation for WLAN, but to which the embodiments of the present invention are not limited. In certain WLAN embodiments, one or more of user stations (STAs) (e.g. stations 110-116) and/or network access points (APs) (e.g., 120) may be adapted to establish various quality of service (QoS) levels for data transmissions. QoS stations (QSTAs) and QoS access points (QAPs) may be implemented in network 100 to facilitate the exchange of information with various user priorities (UPs) in order to support applications with QoS requirements.

In one example implementation eight UPs may be identified for each media access control (MAC) service data unit (MSDU) to denote traffic categories (TC) reflecting various QoS levels. QoS levels may be negotiated in this example implementation by exchanging QoS characteristics of a data flow between non-AP QSTAs. These QoS characteristics may be exchanged, for example, by sending a request from a QSTA to a QAP identifying minimum service level requirements for an application residing on the QSTA. In one example implementation, this request may included as part of a traffic specification (TSPEC) request however, the embodiments of the invention are in no way limited to this example. The TSPEC request describes the traffic characteristics and QoS requirements of a traffic stream (TS) requested by a user station (e.g., based on an application's needs). The AP may then determine if there are sufficient available resources to commit to the requested level of service and send a TSPEC response confirming whether the level of service can be provided.

A main purpose of the TSPEC is to reserve resources within an AP (sometimes referred to a hybrid coordinator (HC)) and/or its scheduling behavior. While TSPEC requests and responses are used in certain example implementations of the inventive embodiments, the present invention is not limited to any specific protocols or message formats for negotiating various levels of service between peers in a wireless network.

Although detailed QoS configurations are not important to the scope of this disclosure, the general capability for network 100 to oblige various service levels based on exchanged information such QoS parameters or priority identifiers contained in a TSPEC may provide benefits for transfer of certain media types (e.g. streaming audio and/or video data).

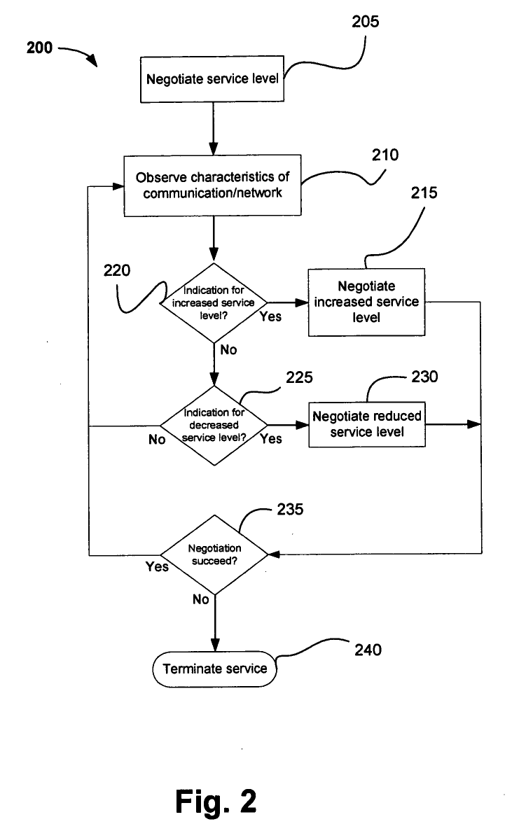

Turning to FIG. 2, a process 200 for communicating in a wireless network adapted to provide various service levels generally includes negotiating 205 a first level of service between peers of the wireless network and modifying 215, 230 the level of service based on observing 210 one or more characteristics of the communication link and/or wireless network.

Negotiating 205 the initial level of service may be performed as described previously in respect to the example WLAN example embodiments. Accordingly, from a client perspective, negotiating the level of service may include a user station sending a request to a network access station specifying a minimum data rate and/or physical (PHY) link rate parameter desired for a traffic stream and/or receiving information (e.g., a response or autonomous message) from a network access station indicating a level of service (and/or parameters corresponding to that level of service) that will be provided.

From a server perspective, negotiating the level of service may include a network access station receiving a request from a client indicating a level of service desired (e.g., minimum data rate and/or PHY rate), determining whether a certain level of service can be provided based on existing commitments and/or channel conditions, scheduling the level of service if desired, and/or sending information (e.g., a response or autonomous message) to a client station indicating a level of service that will be provided.

Various characteristics of the communication and/or network may be monitored 205 by the AP and/or user stations and used to determine 220, 225 whether the service level should be modified 215, 230. If desired, the level of service may be negotiated upward 215 to increase the level of service or negotiated downward 230 to decrease the level of service. If the new level of service cannot be successfully negotiated 235, the peers may either maintain the current level of service or the communication may be terminated 240. In practical implementations, it is unlikely that service would be terminated due to an upward negotiation failure. However, downward negotiation may specified as a “put up or shut up” command from the AP.

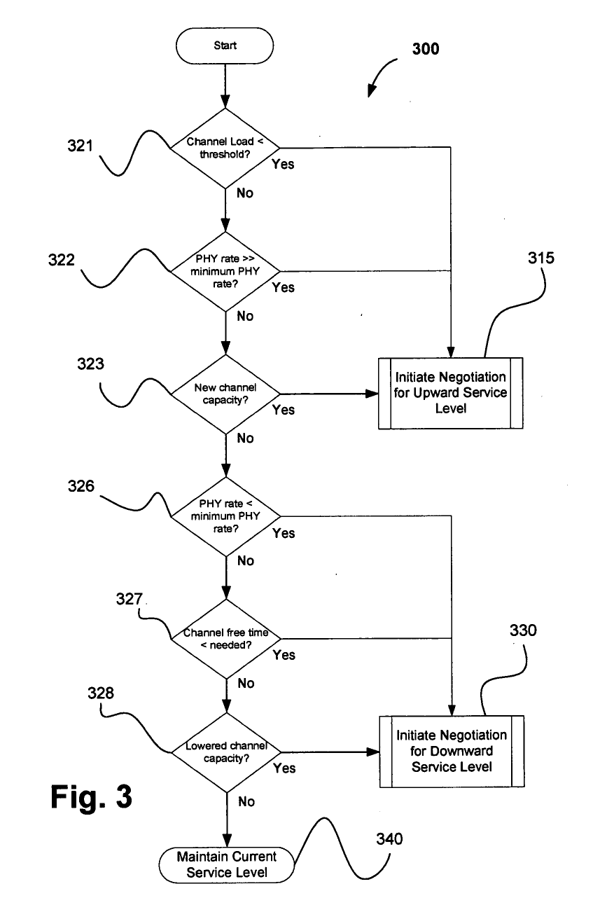

Turning now to FIG. 3, an exemplary process 300 is outlined for determining whether a service level should be modified based on observations of the network/communication. Among potential example indications (220, FIG. 3) for initiating 315 negotiation for a higher level of service may include an observation 321 by the AP that a channel load is less than some threshold value. The channel load may be the actual traffic (e.g., instantaneous, peak or time-averaged) for a particular communication channel. In addition or alternatively, the AP may evaluate the channel load by comparing the maximum committed value for each TSPEC, instead of the actual channel load, to the threshold value if desired. Channel load measured as a fraction of time the channel is busy may be a useful indicator.

Further, initiating 315 a higher service level may occur when it is observed 322 that the actual physical (PHY) link rate used by a TSPEC is significantly higher than a minimum PHY rate negotiated for the initial (or current) service level. In this respect, “significantly” may mean for example, a fixed threshold above last negotiated values. The actual PHY rate may be an instantaneous measurement, peak, or an average of rates over some period of time. The AP may avoid repeated refused renegotiations by recording a last offered minimum PHY rate and only attempting a renegotiation if the actual (observed rate) is higher than the last offered PHY rate and the minimum PHY rate negotiated in the original TSPEC.

Further, a higher service level may be negotiated 315 when additional channel capacity becomes available 323, for example when some other TSPEC is deleted or removed. Any combination of the foregoing indications or any other relevant factor may be used for triggering 315 upward negotiation of the service level.

Potential example indications (e.g., 230; FIG. 3) for initiating 330 a lower level of service may stem from an observation 326 that the actual physical link rate (e.g., instantaneous, peak or averaged over a period of time) is less than the minimum physical link rate specified in a TSPEC.

A lower level of service may also be initiated 330 upon an observation 327 that the channel free time is not sufficient to service all existing TSPEC commitments. This situation might arise, for example, if a nearby co-channel AP starts operation or a non-network device is causing interference. Further, an AP processing requests to create a new TSPEC or modify an existing TSPEC may have an impact on the channel capacity and thus also be an indication 328 for reducing the service level.

Embodiments of the present invention may be configured so that the level of service may be modified for any reason when requested by one of the peers in the network. However, renegotiation is generally initiated by the AP by sending a TSPEC suggestion to the STA containing the proposed new service parameters. The STA may accept the proposal as specified or modify it to some other level, for example, to reduce the level of service to match a specific application traffic profile. In the case of upward negotiations, the STA may refuse the suggestion, meaning that it has no use for additional resources. In the case of downward negotiations, the STA may also refuse the suggestion to reduce the service level. However, in certain embodiments, the STA may only be allowed to refuse a lower service level when the reason is to admit some new TSPEC (e.g., a new device is requesting AP resources). In other cases, the STA must accept the suggestion for lowered service level, make its own suggestion for reduced service level, or delete the TSPEC. If a new service level cannot be satisfactorily negotiated, the current service level could be maintained or the communication link may be terminated (e.g., 240; FIG. 2).

Implementation of the foregoing embodiments in various WLAN standards governed by IEEE 802.11 may require changes to packet formats (e.g., TSPEC format) and to the associated MAC layer management entity (MLME) interface.

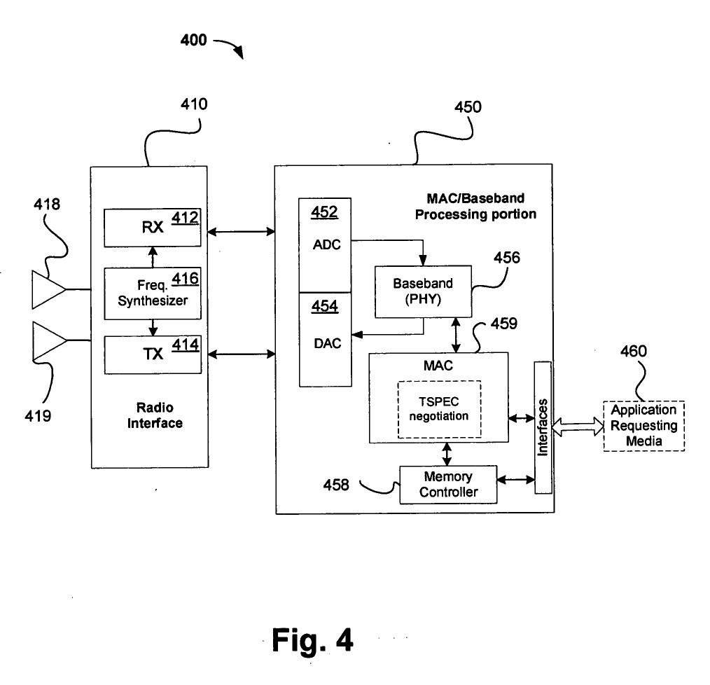

Turning to FIG. 4, an example wireless network apparatus 400 which may be used to implement various embodiments of the present invention may generally include a radio frequency (RF) interface 410 and a baseband and medium access controller (MAC) processor portion 450.

In one example embodiment, RF interface 410 may be any component or combination of components adapted to send and receive multi-carrier modulated signals although the invention is not limited to any particular modulation scheme. RF interface may include a receiver 412, transmitter 414 and frequency synthesizer 416. Interface 410 may also include bias controls, a crystal oscillator and/or one or more antennas 418, 419 if desired. Furthermore, RF interface 410 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description thereof is therefore omitted.

In some embodiments interface 410 may be configured to be compatible with one or more of the Institute of Electrical and Electronics Engineers (IEEE) 802.11 frequency band standards for wireless local area networks (WLANs), however compatibility with other standards is also possible. Most preferably, interface 410 is configured for compatibility and/or backward compatibility with the IEEE 802.11(a-b) (g) and/or (n) standards for WLAN.

Baseband and MAC processing portion 450 communicates with RF interface 410 to process receive/transmit signals and may include, by way of example only, an analog-to-digital converter 452 for down converting received signals, a digital to analog converter 454 for up converting signals for transmission, a baseband processor 456 for physical (PHY) link layer processing of respective receive/transmit signals, and one or more memory controllers 458 for managing read-write operations from one or more internal and/or external memories (not shown). Processing portion 450 may also include a processor 459 for medium access control (MAC)/data link layer processing.

In certain embodiments of the present invention, processor 459 and/or additional circuitry may be adapted to handle requests for network media from an external or internal application 460 and to perform the actions for generating TSPEC requests and/or handling TSPEC responses as described previously. Alternatively or in addition, baseband processor 456 may share processing for certain of these functions or perform these processes independent of processor 459. MAC and PHY processing may also be integrated into a single component if desired. While not shown, apparatus 400 may include, or interface with, a station management entity (SME) which may assist in negotiating and/or adapting the service level.

Apparatus 400 may be a wireless mobile station (STA) such as a cell phone, personal digital assistant, computer, personal entertainment device or other equipment and/or network adaptor therefore. Accordingly, the previously described functions and/or specific configurations of apparatus 400 could be included or omitted as suitably desired.

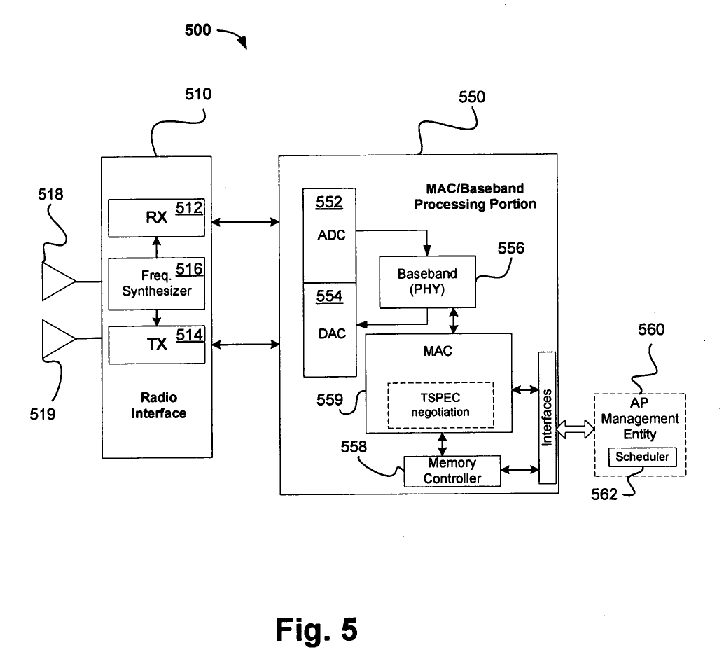

Referring to FIG. 5, an example network apparatus 500 (e.g. 120; FIG. 1) adapted to negotiate and provide various levels of service in a wireless network is shown. Network access apparatus 500 is similar in nature to apparatus 400 of FIG. 4, and thus corresponding reference numerals may denote similar components. However, apparatus 500 may additionally include, or interface with, an AP management entity 560. AP management entity 560 may be any internal, external or distributed component, combination of components and/or machine readable code, which functions to manage AP performance and/or communications with various mobile stations including reserving resources and/or scheduling (e.g., via scheduler 562) transmissions. AP management entity 560 alone or in combination with various other components (e.g., MAC 559) may control service level negotiation and adaptation functions.

The components and features of apparatuses 400 and 500 may be implemented using any combination of discrete circuitry, application specific integrated circuits (ASICs), logic gates and/or single chip architectures. Further, the features of apparatus 400, 500 may be implemented using microcontrollers, programmable logic arrays and/or microprocessors or any combination of the foregoing where suitably appropriate.

It should be appreciated that the example apparatuses 400, 500 shown in the block diagrams of FIGS. 4 and 5 are only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Embodiments of the present invention may be implemented using single input single output (SISO) systems. However, as shown in FIGS. 4 and 5, certain preferred implementations may use multiple input multiple output (MIMO) architectures having multiple antennas (e.g., 418, 419; FIGS. 4 and 518, 519; FIG. 5). Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the inventive embodiments.

Unless contrary to physical possibility, the inventor envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

1. A method for communicating in a wireless network, the method comprising:
negotiating a level of service for a data transfer between peers of the wireless network; and
modifying the level of service based on a one or more characteristics of the wireless network.

2. The method of claim 1 wherein the level of service includes at least one of a minimum data rate or a minimum physical link rate.

3. The method of claim 1 wherein modifying the level of service comprises:
negotiating a higher level of service when a channel load is less than a threshold value.

4. The method of claim 2 wherein modifying the level of service comprises:
negotiating a higher level of service when an actual physical link rate is higher than the minimum physical link rate.

5. The method of claim 1 wherein modifying the level of service comprises:
negotiating a higher level of service when additional channel capacity becomes available.

6. The method of claim 2 wherein modifying the level of service comprises:
negotiating a lower level of service when an actual physical link rate is less than the minimum physical link rate.

7. The method of claim 2 wherein modifying the level of service comprises:
negotiating a lower level of service when available channel capacity is not enough to support the minimum data rate.

8. The method of claim 1 wherein modifying the level of service comprises:
negotiating a lower level of service when a third party station requires a commitment or change in commitment of resources from an AP.

9. The method of claim 1 wherein the wireless network comprises a wireless local area network (WLAN).

10. The method of claim 1 wherein the data transfer is communicated using orthogonal frequency division multiplexing (OFDM) modulation.

11. The method of claim 1 wherein negotiating a level of service comprises a mobile station sending a transmission specification (TSPEC) request to an access point (AP).

12. The method of claim 1 wherein modifying the level of service comprises an access point (AP) sending a transmission specification (TSPEC) suggestion to a mobile station.

13. An apparatus for use in a wireless network, the apparatus comprising:
a processing portion adapted to negotiate a level of service including a minimum data transmission rate and a minimum physical (PHY) rate for a communication link, and modify the level of service based on a status of the wireless network.

14. The apparatus of claim 13 further comprising:
a radio frequency (RF) interface coupled to the processing circuit.

15. The apparatus of claim 13 wherein the apparatus comprises at least a portion of a mobile station and wherein the processing portion is configured to generate a request specifying the minimum data transmission rate and the minimum physical link rate.

16. The apparatus of claim 13 wherein the apparatus comprises at least a portion of an access point (AP) and wherein the processing portion is configured to generate a suggestion to modify the level of service.

17. The apparatus of claim 16 wherein the suggestion is to increase the level of service in response to at least one of (i) an observation that a channel load is less than a threshold; (ii) an observation that an actual physical link rate is higher than the minimum physical link rate; or (iii) additional channel capacity becoming available.

18. The apparatus of claim 16 wherein the suggestion is to reduce the level of service in response to at least one of (i) an actual physical link rate less than the minimum physical link rate; (ii) a channel capacity insufficient to service existing commitments; (iii) a request to create one or more new transmission commitments; or (iv) a request to modify one or more existing transmission commitments.

19. The apparatus of claim 13 wherein the wireless network comprises a wireless local area network (WLAN).

20. The apparatus of claim 13 wherein the communication link is facilitated using orthogonal frequency division multiplexing (OFDM) modulation.

21. The apparatus of claim 14 further comprising at least two antennas coupled to the RF interface to provide multiple input multiple output (MIMO) capability.

22. A system comprising:
a processing portion adapted to negotiate a level of service for a communication link in a wireless network and subsequently modify the level of service based on one or more parameters; and
at least two antennas communicatively coupled to the processing portion to facilitate multiple input multiple output (MIMO) operation.

23. The system of claim 22 wherein the system comprises a mobile station and wherein the processing portion is configured to generate a request specifying a minimum data transmission rate and a minimum physical link rate for negotiating the level of service.

24. The system of claim 22 wherein the system comprises a wireless local area network (WLAN) access point (AP) and wherein the processing portion is configured to generate a suggestion to modify the level of service.

25. The system of claim 24 wherein the suggestion is to increase the level of service in response to at least one of (i) an observation that a channel load is less than a threshold; (ii) an observation that an actual physical link rate is higher than the minimum physical link rate; or (iii) additional channel capacity becoming available.

26. The system of claim 24 wherein the suggestion is to reduce the level of service in response to at least one of (i) an actual physical link rate less than the minimum physical link rate; (ii) a channel capacity insufficient to service existing commitments; (iii) a request to create one or more new transmission commitments; or (iv) a request to modify one or more existing transmission commitments.

27. The device of claim 24 further comprising:
an RF interface coupled with the processing portion and the at least two antennas.
